(19) United States
(12) Patent Application Publication
(10) Pub. No.: US 2013/0246160 A1
(43) Pub. Date: Sep. 19, 2013

(54) SYSTEM AND METHOD FOR CONDUCTING RANDOMIZED TRAILS ON AD EXCHANGES

(71) Applicant: Ayman FARAHAT, San Francisco, CA (US)

(72) Inventor: Ayman FARAHAT, San Francisco, CA (US)

(73) Assignee: Yahoo! Inc., Sunnyvale, CA (US)

(21) Appl. No.: 13/421,506

(22) Filed: Mar. 15, 2012

(51) Int. Cl. G06Q 30/02

(52) U.S. Cl. 705/14.43

(57) ABSTRACT

A system and method for conducting randomized trials on ad exchanges are disclosed. A list of all cookies on an advertising exchange may be compiled, and a random sample of cookies may be drawn from the list of cookies for each of one or more test groups and a control group. One or more users from each of the one or more test groups may be targeted if each of the one or more users satisfy predetermined targeting criteria of an advertising campaign and if each of the one or more users satisfy one or more predetermined test criteria. One or more users from the control group may be targeted if each of the one or more users satisfy the predetermined targeting criteria. Audience reactions from each of the test groups and the control may be compared.

### BACKGROUND

Advertising exchanges are marketplaces that facilitate the buying and selling of online advertising. Ad exchanges are rapidly expanding both in terms of number of impressions and users and also in the availability of various tools such as targeting, bidding agents and optimization mechanisms. As new tools and algorithms get introduced it is important to evaluate the marginal contribution or causal impact of these tools and algorithms, i.e., the lift over the current baseline.

However, ad exchanges do not currently have a built in test and control framework. Techniques are needed to facilitate measurement of the causal impact these tools and algorithms have on online advertising campaigns.

### SUMMARY

Some embodiments of the invention provide a system and method for conducting randomized trials on ad exchanges. A list of all cookies on an advertising exchange may be compiled. For example, an advertising exchange may have xcookies stored for each of its users, and a list of all xcookies on the advertising exchange's servers may be compiled. A random sample of cookies may be drawn from the list of cookies for each of one or more test groups and a control group, wherein the number of cookies in the random sample is based at least in part on a predetermined sampling ratio. In other words, for each test group and for the control group, random samples of cookies may be drawn from the list and assigned to the test groups and the control group. The sampling ratio may be based on, for example, the size of the test group(s) relative to the control group. The test criteria may include any factors that are being tested. For example, if an advertiser wants to test a retargeting line, only users who have the retargeting pixel, and users who satisfy the test group criteria may be targeted.

One or more users from each of the one or more test groups may be targeted with advertisements if each of the one or more users satisfy predetermined targeting criteria of an advertising campaign and if each of the one or more users satisfy one or more predetermined test criteria. The targeting criteria may include, for example, demographic information such as age and gender, income level, interests and behaviors. One or more users from the control group may be targeted with advertisements if each of the one or more users satisfy the predetermined targeting criteria.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

### DETAILED DESCRIPTION

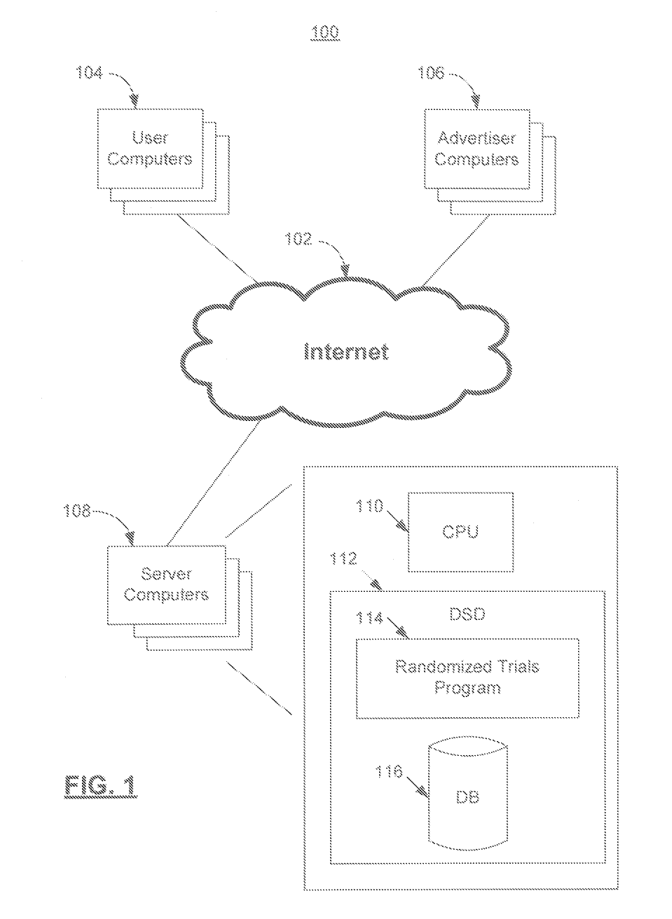

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as cell phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Randomized Trials Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

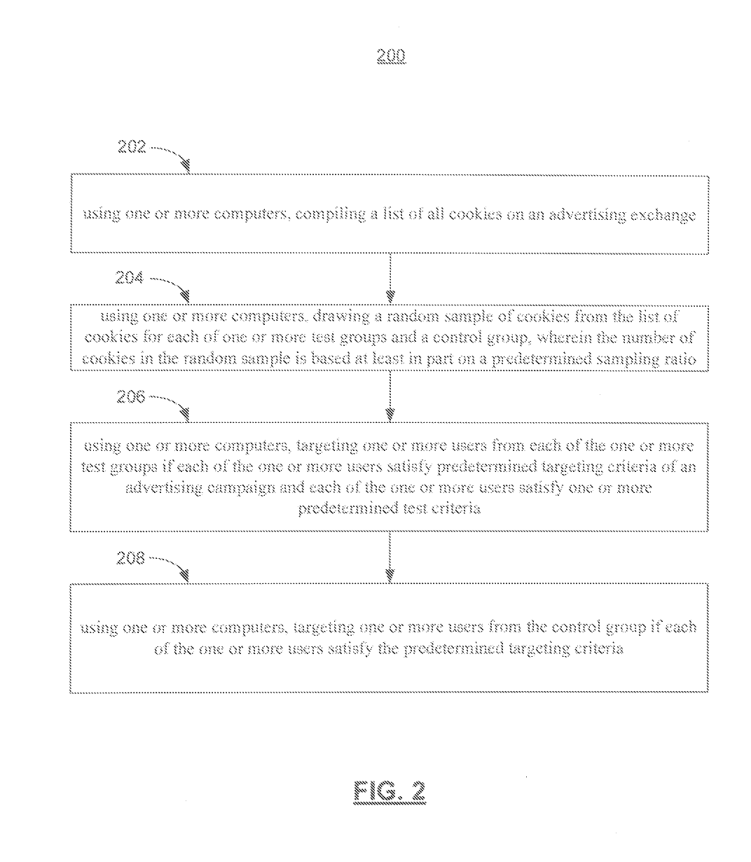

FIG. 2 is a flow diagram illustrating a method 200 according to one embodiment of the invention. At step 202, using one or more computers, a list of all cookies on an advertising exchange may be compiled. For example, an advertising exchange may have xcookies stored for each of its users, and a list of all xcookies on the advertising exchange's servers may be compiled. At step 204, using one or more computers, a random sample of cookies may be drawn from the list of cookies for each of one or more test groups and a control group, wherein the number of cookies in the random sample is based at least in part on a predetermined sampling ratio. In other words, for each test group and for the control group, random samples of cookies may be drawn from the list and assigned to the test groups and the control group. The sampling ratio may be based on, for example, the size of the test group(s) relative to the control group. The test criteria may include any factors that are being tested. For example, if an advertiser wants to test a retargeting line, only users who have the retargeting pixel, and users who satisfy the test group criteria may be targeted.

In some embodiments, time increment-based randomization, as exemplified as follows, may be utilized, such as in randomization and bucketization, such as bucketization of users into one or more test groups and control groups. In some embodiments, bucketization and randomization, or further bucketization or randomization, can be accomplished or facilitated using one or more time-related aspects or parameters. For example, bucketization may include utilization of a short time parameter, such as a number of seconds or fractions of seconds, which can help keep non-experimental, non-test, time-varying variables consistent between buckets, since generally very little changes, or changes much, in such a short amount of time, even though much may change in longer periods of time, such as over hours or days. For example, bucket I may include users arriving every even second, whereas bucket 2 could include users arriving every odd second, or increments or fractions of a second, etc. Furthermore, multiple test buckets may used, in which case, for example, users arriving in odd seconds may be used for the control bucket, users arriving in even seconds that are divisible by 3 may be a first experimental bucket, users arriving in even seconds that are divisible by five may be used for a second experimental bucket, etc. Furthermore, such short time differentiation can also be used to divide individual buckets into multiple buckets, etc. In this sense, the time differentiation can be used in addition to, or as an overlay to, existing bucketing techniques, or can be used alone.

Furthermore, in some embodiments, time increment-based randomization can be used in generating multiple test or treatment groups. As one example, in a hypothetical situation, if a user arrives at an even second, the user may see ad A, whereas if the user arrives at an odd second the user may see ad B, and each user may have three visits. In such a situation, eight different sequences can be generated, such as AAA, AAB, ABA, etc., which could otherwise require eight pre-determined buckets.

At step 206, using one or more computers, one or more users from each of the one or more test groups may be targeted with advertisements if each of the one or more users satisfy predetermined targeting criteria of an advertising campaign and if each of the one or more users satisfy one or more predetermined test criteria. The targeting criteria may include, for example, demographic information such as age and gender, income level, interests and behaviors. At step 208, using one or more computers, one or more users from the control group may be targeted with advertisements if each of the one or more users satisfy the predetermined targeting criteria.

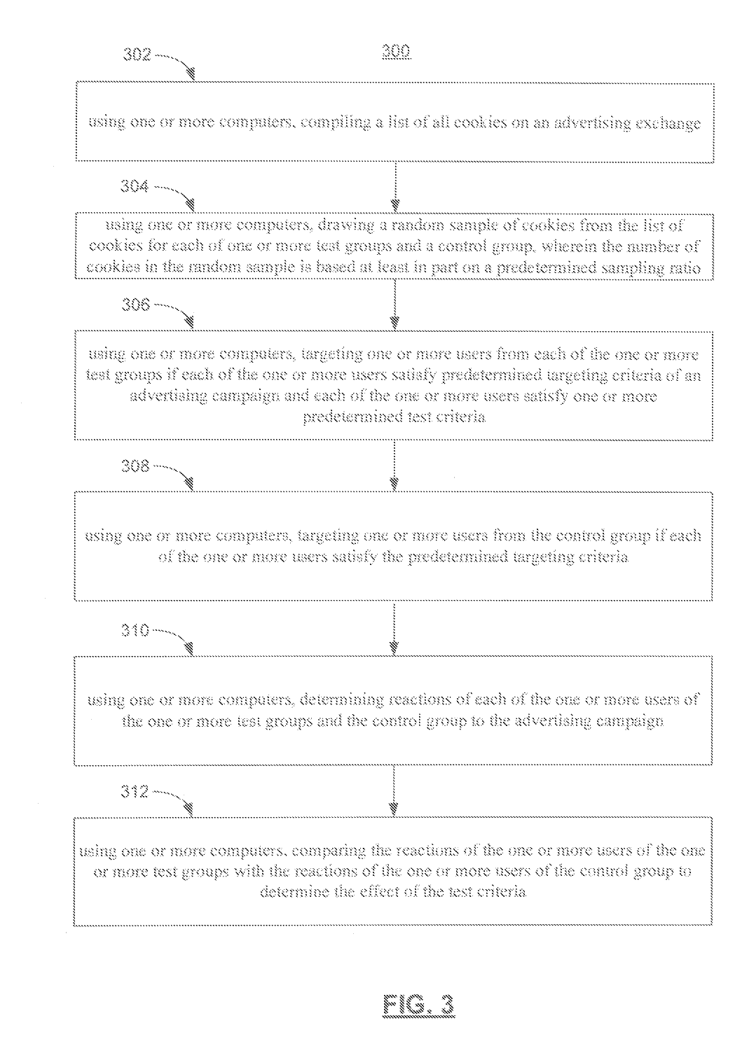

FIG. 3 is a flow diagram illustrating a method 300 according to one embodiment of the invention. At step 302, using one or more computers, a list of all cookies on an advertising exchange may be compiled. For example, an advertising exchange may have xcookies stored for each of its users, and a list of all xcookies on the advertising exchange's servers may be compiled. At step 304, using one or more computers, a random sample of cookies may be drawn from the list of cookies for each of one or more test groups and a control group, wherein the number of cookies in the random sample is based at least in part on a predetermined sampling ratio. In other words, for each test group and for the control group, random samples of cookies may be drawn from the list and assigned to the test groups and the control group. The sampling ratio may be based on, for example, the size of the test group(s) relative to the control group. The test criteria may include any factors that are being tested. For example, if an advertiser wants to test a retargeting line, only users who have the retargeting pixel, and users who satisfy the test group criteria may be targeted.

At step 306, using one or more computers, one or more users from each of the one or more test groups may be targeted with advertisements if each of the one or more users satisfy predetermined targeting criteria of an advertising campaign and if each of the one or more users satisfy one or more predetermined test criteria. The targeting criteria may include, for example, demographic information such as age and gender, income level, interests and behaviors. At step 308, using one or more computers, one or more users from the control group may be targeted with advertisements if each of the one or more users satisfy the predetermined targeting criteria.

At step 310, using one or more computers, reactions of each of the one or more users of the one or more test groups and the control group to the advertising campaign may be determined. The reactions may include, for example, purchases, conversions, etc. At step 312, using one or more computers, the reactions of the one or more users of the one or more test groups may be compared with the reactions of the one or more users of the control group to determine the effect of the test criteria.

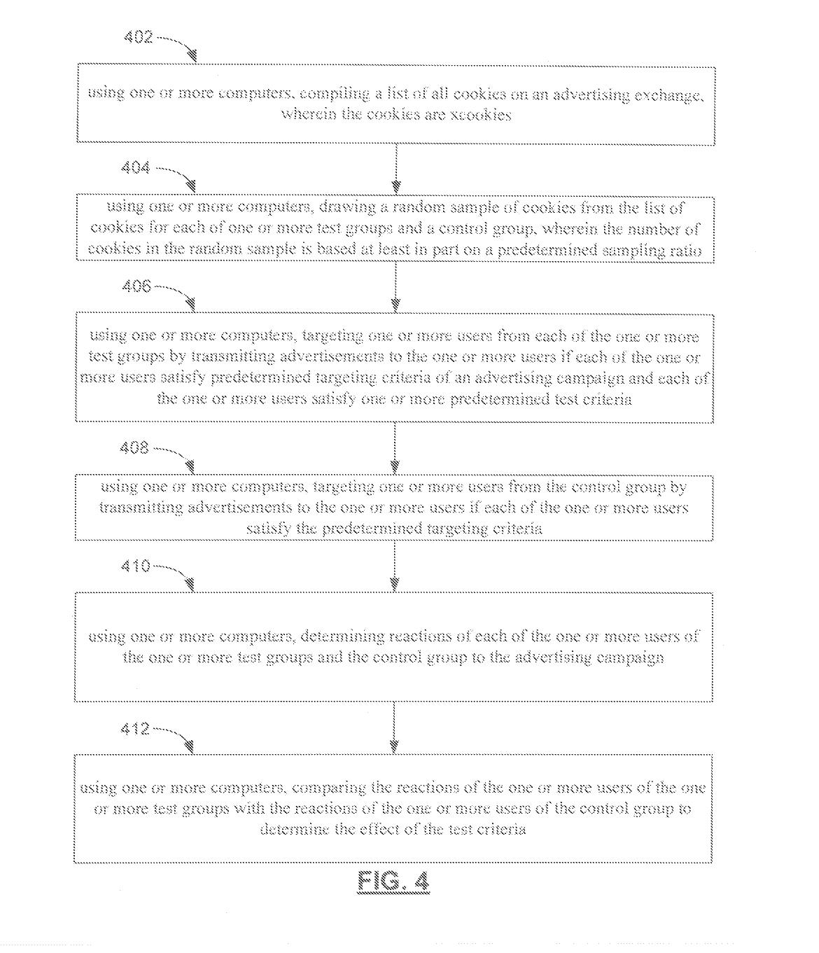

FIG. 4 is a flow diagram illustrating a method 400 according to one embodiment of the invention. At step 402, using one or more computers, a list of all cookies on an advertising exchange may be compiled, wherein the cookies are xcookies corresponding to users. At step 404, using one or more computers, a random sample of cookies may be drawn from the list of cookies for each of one or more test groups and a control group, wherein the number of cookies in the random sample is based at least in part on a predetermined sampling ratio. In other words, for each test group and for the control group, random samples of cookies may be drawn from the list and assigned to the test groups and the control group. The sampling ratio may be based on, for example, the size of the test group(s) relative to the control group. The test criteria may include any factors that are being tested. For example, if an advertiser wants to test a retargeting line, only users who have the retargeting pixel, and users who satisfy the test group criteria may be targeted.

At step 406, using one or more computers, one or more users from each of the one or more test groups may be targeted by having advertisements transmitted to them if each of the one or more users satisfy predetermined targeting criteria of an advertising campaign and if each of the one or more users satisfy one or more predetermined test criteria. The targeting criteria may include, for example, demographic information such as age and gender, income level, interests and behaviors. At step 308, using one or more computers, one or more users from the control group may be targeted by having advertisements transmitted to them if each of the one or more users satisfy the predetermined targeting criteria.

At step 410, using one or more computers, reactions of each of the one or more users of the one or more test groups and the control group to the advertising campaign may be determined. The reactions may include, for example, purchases, conversions, etc. At step 412, using one or more computers, the reactions of the one or more users of the one or more test groups may be compared with the reactions of the one or more users of the control group to determine the effect of the test criteria.

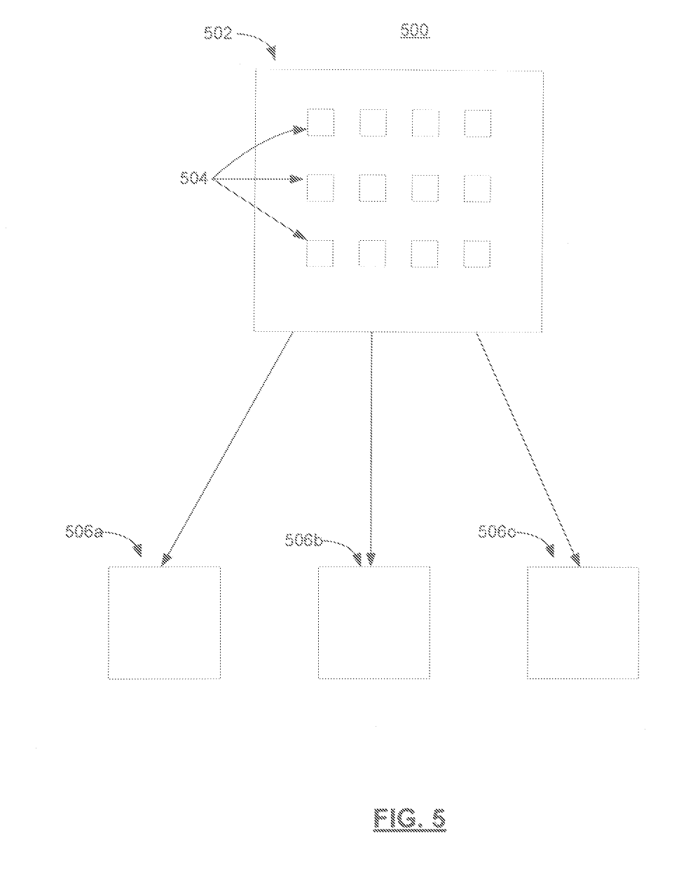

FIG. 5 is a block diagram 500 illustrating one embodiment of the invention. One or more data stores or databases 502 are depicted. Various types of information may be stored in the database 502. In particular, cookies 504 corresponding to users are depicted. The information stored in database 502 may be obtained, gathered, or generated in various ways from various sources. Cookies 504 may be, for example, xcookies. The cookies may be randomly sampled into one or more groups 506a, 506b and 506c. The groups may be designated as, for example, test groups and/or control groups. The cookies may be sampled according to a sampling ratio based on, for example, the size of the control group relative to the test group.

While the invention is described with reference to the above drawings, the drawings are intended to be illustrative, and the invention contemplates other embodiments within the spirit of the invention.

1. A method comprising:
using one or more computers, compiling a list of all cookies on an advertising exchange;
using one or more computers, drawing a random sample of cookies from the list of cookies for each of one or more test groups and a control group, wherein the number of cookies in the random sample is based at least in part on a predetermined sampling ratio, comprising utilization of time increment-based randomization in determining users in the one or more test groups and in the control group;
using one or more computers, targeting one or more users from each of the one or more test groups if each of the one or more users satisfy predetermined targeting criteria of an advertising campaign and each of the one or more users satisfy one or more predetermined test criteria; and
using one or more computers, targeting one or more users from the control group if each of the one or more users satisfy the predetermined targeting criteria.

2. The method of claim 1, wherein utilization of time increment-based randomization includes bucketization of users utilization of recurring increments of time.

3. The method of claim 1, wherein the targeting criteria comprise one or more of demographic information, interests and behaviors.

4. The method of claim 1, wherein the predetermined sampling ratio is based at least in part on a number of users in the control group.

5. The method of claim 1, wherein the cookies are stored on or more servers at an advertising exchange.

6. The method of claim 1, further comprising:
using one or more computers, determining reactions of each of the one or more users of the one or more test groups and the control group to the advertising campaign.

7. The method of claim 1, wherein targeting the one or more users from the one or more test groups comprises transmitting one or more advertisements to each of the one or more users.

8. The method of claim 1, wherein targeting the one or more users from the control group comprises transmitting one or more advertisements to each of the one or more users.

9. The method of claim 6, further comprising:
using one or more computers, comparing the reactions of the one or more users of the one or more test groups with the reactions of the one or more users of the control group to determine the effect of the test criteria.

10. A system comprising:
one or more server computers coupled to a network; and
one or more databases coupled to the one or more server computers;
wherein the one or more server computers are for:
compiling a list of all cookies on an advertising exchange;
drawing a random sample of cookies from the list of cookies for each of one or more test groups and a control group, wherein the number of cookies in the random sample is based at least in part on a predetermined sampling ratio;
targeting one or more users from each of the one or more test groups if each of the one or more users satisfy predetermined targeting criteria of an advertising campaign and each of the one or more users satisfy one or more predetermined test criteria; and
targeting one or more users from the control group if each of the one or more users satisfy the predetermined targeting criteria

11. The system of claim 10, wherein the targeting criteria comprise one or more of demographic information, interests and behaviors.

12. The system of claim 10, wherein the predetermined sampling ratio is based at least in part on a number of users in the control group.

13. The system of claim 10, wherein the cookies are xcookies.

14. The system of claim 10, wherein the cookies are stored on or more servers at an advertising exchange.

15. The system of claim 10, wherein the one or more server computers are further configured for:
determining reactions of each of the one or more users of the one or more test groups and the control group to the advertising campaign.

16. The system of claim 10, wherein targeting the one or more users from the one or more test groups comprises transmitting one or more advertisements to each of the one or more users.

17. The system of claim 10, wherein targeting the one or more users from the control group comprises transmitting one or more advertisements to each of the one or more users.

18. The system of claim 15, wherein the one or more server computers are further configured for:
comparing the reactions of the one or more users of the one or more test groups with the reactions of the one or more users of the control group to determine the effect of the test criteria.

19. The system of claim 16, wherein the advertisements comprise one or more of textual, graphical, audio, and video data.

20. A computer readable medium or media containing instructions for executing a method comprising:
using one or more computers, compiling a list of all cookies on an advertising exchange;
using one or more computers, drawing a random sample of cookies from the list of cookies for each of one or more test groups and a control group, wherein the number of cookies in the random sample is based at least in part on a predetermined sampling ratio;
using one or more computers, targeting one or more users from each of the one or more test groups if each of the one or more users satisfy predetermined targeting criteria of an advertising campaign and each of the one or more users satisfy one or more predetermined test criteria;
using one or more computers, targeting one or more users from the control group if each of the one or more users satisfy the predetermined targeting criteria;
using one or more computers, determining reactions of each of the one or more users of the one or more test groups and the control group to the advertising campaign; and
using one or more computers, comparing the reactions of the one or more users of the one or more test groups with the reactions of the one or more users of the control group to determine the effect of the test criteria.
